(19) United States
(12) Patent Application Publication
(10) Pub. No.: US 2012/0266056 A1
(43) Pub. Date: Oct. 18, 2012

(54) INTERACTIVE ELECTRONIC DOCUMENT

(76) Inventor: Frank Shaffer, Main Beach (AU)

(21) Appl. No.: 13/500,629

(22) PCT Filed: Oct. 4, 2010
(86) PCT No.: PCT/AU2010/001301

§ 371 Date: Jun. 29, 2012

Related U.S. Application Data
(60) Provisional application No. 61/272,545, filed on Oct. 5, 2009.

(51) Int. Cl. G06F 17/00

(52) U.S. Cl. 715/201; 715/255

(57) ABSTRACT

A method for providing an electronic document to a user in which the electronic document has one or more pages and one or more content placeholders associated with the pages. The method includes the steps of: providing content for insertion into the electronic document, inserting content into one or more content placeholders in response to a request by the user, and displaying the one or more pages of the electronic document with the content inserted in the one or more content placeholders.

### TECHNICAL FIELD

The present invention generally relates to methods, software and apparatus for providing an electronic document. The invention also relates to methods, software and apparatus for providing content for insertion into an electronic document.

### BACKGROUND

Electronic documents such as e-books provide a digital equivalent of a printed document, and may be displayed and read on computers and hand held devices including mobile telephones, PDA's and dedicated e-book readers. In recent times, use of electronic documents has increased and audio and video together with text have been used to enhance a user's experience in reading the document.

Electronic documents are generally of a static nature, designed to be read once only. However, in some circumstances, an electronic document is purchased with the intention of reading it repeatedly. For example, a child may read a favourite story over and over again. As time passes, however, the child may lose interest in the electronic document. This limits the entertainment value that can be obtained from the electronic document.

Accordingly, it would be desirable to provide an electronic document that is more engaging to the user.

A reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

### DISCLOSURE OF THE INVENTION

The present invention provides a method for providing an electronic document to a user, the electronic document having one or more pages and one or more content placeholders associated with the pages, the method including the steps of: (a) providing content for insertion into the electronic document, (b) inserting content into one or more content placeholders in response to a request by the user, and (c) displaying the one or more pages of the electronic document with the content inserted in the one or more content placeholders.

The method of the present invention provides an electronic document where the content is customisable by the user. Content may be added to the electronic document or existing content replaced by new content. For example, the electronic document may be a children's story book. After reading the book a few times, the user may personalise the story by replacing content to give the electronic document a different look and feel. Advantageously, the electronic document may therefore be more engaging to the user, and user may maintain interest in the electronic document over multiple readings.

In another example, the electronic document may be a single page, such as a card for sending to a friend for a birthday or other event. The card may be customised by adding photos or videos, and may thereby be personalised for the recipient.

Providing content for insertion into the electronic document may include downloading content from an external server via a network such as the internet, obtaining content saved locally at the user's computer or hand held device, copying content from a storage device such as a DVD or USB device or any other means of providing content. Content may be displayed on a page of the document for selection by the user or may be obtained from an external source, such as a website.

The electronic document has one or more content placeholders that content may be inserted into. Each of the one or more content placeholders may define one of a position on one or more pages of the electronic document, a time associated with one or more pages of the electronic document, and both a position on and time associated with one or more pages of the electronic document. For example, the content placeholder may define an area on a page in which the content will appear, and a time after the page is first displayed when the content will be shown or played.

There may be one content placeholder on a page, or any number of content placeholders on a page. Some pages of the electronic document may have no content placeholders. A content placeholder may allow content covering an entire page to be replaced, or it may allow part of the content on the page to be replaced. The electronic document may contain default content in the content placeholder that is displayed when the pages of the electronic document are viewed.

The user can personalise the electronic document by inserting new content into one or more content placeholders. For example, the electronic document may contain indicators that content placeholders exist at certain positions, enabling the user to quickly and easily replace content at these positions.

The indicators may be a highlight, coloured and/or white outline or box. The indicators may appear after the user selects an option of replacing content, for example by clicking on a “images”, “text”, “video” or other interactive options button. Alternatively, the content placeholders may be indicated by buttons on the screen, such as a “sounds”, “smells” or “music” button, and may not visually show a position on the screen that the content will occupy.

The method may further include the step of searching for content in a library of content for insertion into one or more content placeholders on one or more pages of the electronic document. The library may be a library of content stored on an external server, remotely accessible over a network, such as the internet. It is envisaged that the library may be contributed to by many different sources, such as celebrities, politicians, artists, the provider of the electronic document and other users owning the electronic document.

The library of content may alternatively be accessible locally on the user's own computer or hand held device. It could be downloaded from a storage device such as a DVD or USB device, or through an electronic or telecommunications connection, such as from a kiosk or remote server or bank of servers. In another alternative, the library of content may be created by the user from their own personal content and stored locally or uploaded at any time.

The library of content may include content designed for insertion at a selected page of the electronic document. For example, multiple sources may create content for the same page of the document. The method may then include the step of searching for content in a library of content for insertion at the selected page of the electronic document.

The library of content may also include pages that are designed to be inserted between other pages of the electronic document, rather than replace an existing page of the electronic document.

The library of content may alternatively or additionally include content designed for insertion at a selected content placeholder in the electronic document. For example, the content placeholder may be associated with a character in a book. The method may then include the step of searching for content in a library of content for insertion at a selected content placeholder in the electronic document.

Content may form part of one or more different libraries, and libraries may be formed by different sorting and classification of the content. The content may be organised by page or in aggregate in any number of ways. For example, topically, by most popular, by recent posts, by rating systems, calendar basis, by most viewed, by feature, by country, by language.

The content inserted at different content placeholders may be selected from one or more different sources. As described above, the source of the content may include any person or entity that creates content and that is made available to users. Advantageously, having content from different sources may further increase the appeal of the electronic document. For example, one page of the document may be created by a celebrity, and another page may include the user's own personal content (e.g. their mother or father reading in the case of a children's book).

The content may include one or more of an image, a video clip, text, a sound, music, a photograph, a smell, an animation, a game or any other form of media. In one form, the content may be a link to an attachment such as a file, web page or document which is accessed by clicking on a picture icon, text, photo, or tool bar within the content placeholder. For example, in the context of an electronic document related to financial information, a viewer may click on picture of monthly statement in a content placeholder to view a spreadsheet. The content may also include a combination of two or more of these different content types, or two or more of the same content type, such as a slide show of images or a video montage.

In an embodiment, the content includes a video clip of a person reading at least part of the electronic document. Reading the electronic document is to be taken to include either or both of speaking (aural) and acting (visual). The part of the electronic document may include a page, a chapter, a part of a story, all dialogue associated with one character, or any other predetermined part of the document. For example, the user may personalise the electronic document so that a video clip of a different person reading a page of the document is inserted into a content placeholder on each page. This may further increase interest of the document. The user may select a favourite narration of each page and include this content in the electronic document. The content may be swapped and substituted as desired.

The method may further include steps of (a) providing one or more pages for insertion into the electronic document, and (b) inserting a page into the electronic document in response to a request by a user. Advantageously, this allows the user to add new characters or plots to the electronic document, or to conveniently replace an entire page of the document.

The content placeholder may define a position on a number of pages of the electronic document (a “host box”), so that the same content is displayed even when pages of the document are turned. For example, a portion of the frame or screen (such as the top right) may display a video clip that plays regardless of when pages are turned. The video clip may include a narrator, commentator and/or an accompanying music video. One example may include a music video spread out over any number of pages providing a living soundtrack that viewers can replay, adjust, or replace with another music video of their preference. The user may edit, trim, or tailor the host box commentary to reflect or relate to the specific content of each page. Another example may include a parent giving commentary during a children's story, a teacher with a lesson plan, or an individual such as the coach of a team giving commentary during a sports based event or story. The embodiment may include additional forms such as a ticker tape involving recorded or real time commentary, a textual feed such as Twitter™ or sentiment indicators. This ‘host box’ and its parameters may be amongst interactive options, on a tool bar, or part of a preliminary selection process.

The content placeholder may define a page or portion of a page which may act as a “headline”, which plays briefly and contains content, a preview, introduction, warning, and/or highlight of things to come.

The present invention further provides software, and a computer readable media containing software for use with a computer including a processor and associated memory device for storing the software, the software including a series of instructions to cause the processor to carry out steps as described above.

The present invention further provides an apparatus for providing an electronic document to a user, the electronic document having one or more pages and one or more content placeholders associated with the pages, the apparatus including: (i) a processor, (ii) a memory, (iii) a user interface including an input device and an output device, and (iv) a software program resident in memory accessible to the processor, the program executable by the processor to: (a) provide content for insertion into the electronic document, (b) insert content into one or more content placeholders in response to a request by the user, and (c) display the one or more pages of the electronic document with the content inserted in the one or more content placeholders.

The apparatus, for example, may include an electronic book reader, a PDA, mobile phone, computer or other device.

The present invention also provides a method for sharing content with one or more users for insertion in an electronic document having one or more pages and one or more content placeholders associated with the pages, the method including the steps of: (a) creating content for insertion into the electronic document, and (b) transmitting the created content to a library that is searchable by the one or more users for insertion of the content into one or more content placeholders associated with one or more pages of an electronic document.

Software implementing the method may allow for editing and content creation in conjunction with webcams, microphones, user clips and internet searches. For example, the software may allow a user to take a photo of themselves and insert it into a video stored in a content library or downloaded from the internet.

When transmitting the created content to a library, the software may nominate a page of the electronic document that the content is designed to be inserted into and/or nominate a content placeholder in the electronic document that the content is designed to be inserted into. For example, the user may use the interactive options within a page to design or select new content for the content placeholders of that page. When the user indicates that the content is to be shared, the software transmits the content to a library, designating the page and/or content placeholder. The library may include a public library, a user group, or a personal library.

Users may compete to create the most popular content for the electronic document, and may charge other users a price to use content they have created. There may be a ratings system, where users can rate or comment on content from different sources.

The present invention also provides a method for providing content to one or more users for insertion in an electronic document having one or more pages and one or more content placeholders associated with the pages, the method including the steps of: (a) receiving content for inclusion in the electronic document, (b) storing the received content in a library that is searchable by the one or more users, and (c) transmitting content to a user on selection by the user, for insertion at one or more content placeholders in the user's electronic document.

Content can thus be conveniently collected into a library and made available to different users. The received content may be suitable for insertion at a nominated page of the electronic document, and stored in a library of content for insertion at that page. This may allow users who are tired of a specific page of the electronic book, to search for alternative pages having more interesting content. Libraries may be suitable for individual pages, in the aggregate for whole stories, and/or libraries of inserted pages, characters, plots or storyline.

The received content may be suitable for insertion at a nominated content placeholder in the electronic document, and stored in a library of content for insertion at that content placeholder. This may allow users who would like to change part of a page to search for appropriate content.

Again, the content may include any type as described above, and in a preferred form may be a video clip of a person reading at least part of the electronic document.

The present invention further provides a server for providing content to one or more users for insertion in an electronic document having one or more pages and one or more content placeholders associated with the pages, the server including: (a) a processor, (b) a memory storing a library of content for insertion into the electronic document, (c) a user interface including an input device and an output device, and (d) a software program resident in memory accessible to the processor, the program executable by the processor to: (a) receive content for inclusion in the electronic document, (b) store the received content in a library that is searchable by the one or more users, and (c) transmit content to a user on selection by the user, for insertion at one or more content placeholders in the user's electronic document.

Embodiments of the present invention will now be described, by way of example only, with reference to the accompanying drawings. It is to be understood that the particularity of the drawings does not supersede the generality of the preceding description of the invention.

### BRIEF DESCRIPTION OF THE DRAWINGS

FIG. 1 is a schematic diagram of an example network that can be utilised to give effect to a method according to an embodiment of the invention.

FIG. 2 is a functional block diagram of an example processing system that can be connected to the network.

FIG. 3 is a flow chart of a method for providing an electronic document to a user according to an embodiment of the invention.

FIGS. 4A-4D show an example sequence of screen shots showing steps of providing and inserting content according to an embodiment of the invention.

FIGS. 5A-5C show an example sequence of screen shots of a page of an electronic document being displayed according to an embodiment of the invention.

FIGS. 6A-6C show example screen shots of another page of an electronic document being displayed.

FIG. 7 is a flow chart of a method for sharing content with one or more users according to an embodiment of the invention.

FIG. 8 is a flow chart of a method for providing content to one or more users according to an embodiment of the invention.

FIGS. 9A-9C show example screen shots of templates for creating pages for insertion into an electronic document.

### DETAILED DESCRIPTION

### Example of a Network

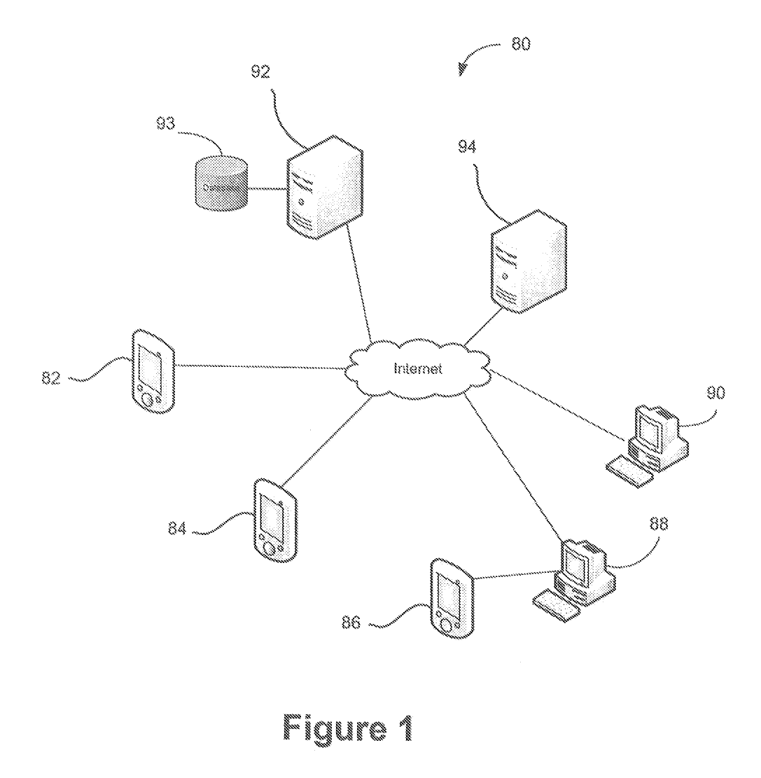

Embodiments of the present invention can be realised over a network, an example of which is shown in FIG. 1.

The network 80 includes one or more client processing systems and one or more server processing systems. In this example, the client processing systems include electronic book readers 82, 84, 86 and personal computers (PCs) 88, 90. The server processing systems include network servers 92 and 94. The client and server processing systems 82, 84, 88, 90 and 94 are connected via the internet 96 and the electronic book reader 86 is connected to the PC 88.

The transfer of information and/or data over the network can be achieved using wired communications means or wireless communications means. The server processing systems 92 and 94 can facilitate the transfer of data between the network and one or more databases, such as database 93.

It will be appreciated that embodiments of the invention may be realised over different networks, such as a MAN (metropolitan area network), WAN (wide area network) or LAN (local area network). Also, embodiments need not take place over a network, and the method steps could occur entirely on a client or server processing system.

### Example of a Processing System

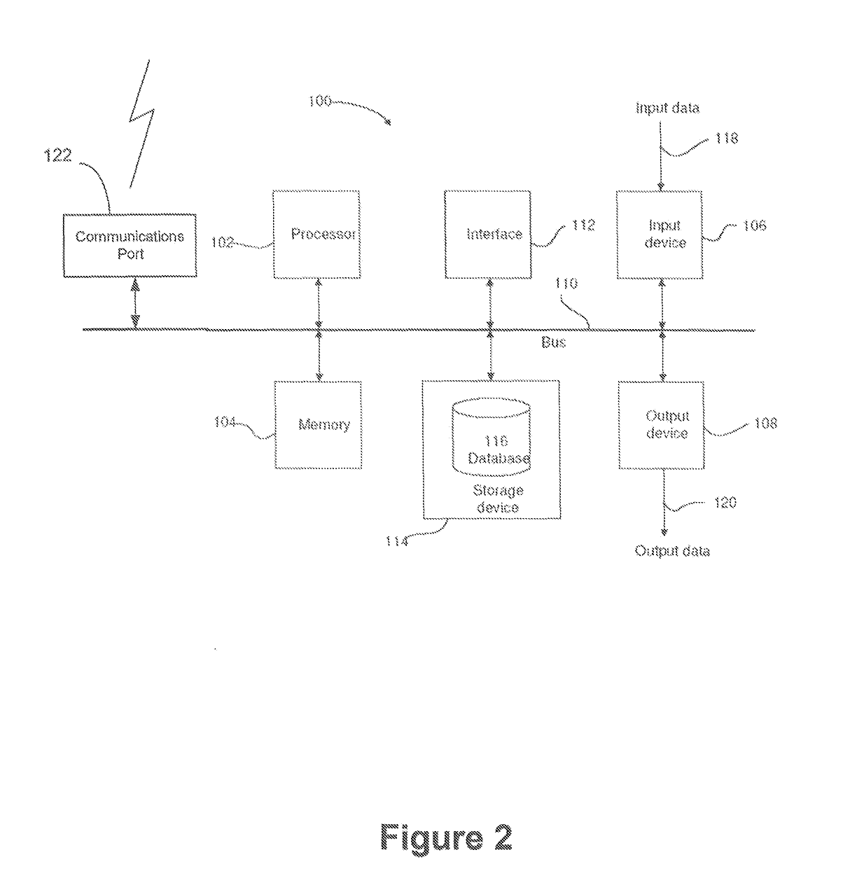

The client and server processing systems 82-94 may include a processing system 100 shown in FIG. 2.

The processing system 100 includes a processor 102 (or processing unit), a memory 104, at least one input device 106, at least one output device 108 and a communications port 122. As is shown, the processor 102, memory 104, input device 106, output device 108 and communications port 122 are typically coupled together via a bus or group of buses 110. In certain embodiments, input device 106 and output device 108 may be the same device such as in the case of, for example, a computer graphics display or handheld device such as an electronic reader, that incorporates a touch-screen.

An interface 112 can also be provided for coupling the processing system 100 to one or more peripheral devices. For example interface 112 may include a PCI card or PC card. At least one storage device 114 which houses at least one database 116 can also be provided.

The memory 104 may include any suitable memory device and including, for example, volatile or non-volatile memory, solid state storage devices, magnetic devices, etc. The memory 104 may typically store an operating system that provides functionality to the processing system 100. A file system and files are also typically stored on the storage device 114 and/or the memory 104. The memory 104 may also include one or more software applications or program data.

The applications running in memory 104 may include electronic document presentation programs, such as Impress™, PowerPoint™, Flash™, Silverlight™, Keynote™, Acrobat™, Mobipocket™, Sprocketcore™, Stanza™, html, javascript or any other suitable application for displaying electronic documents for reading or reviewing.

The processor 102 may include more than one processing device, for example to handle different functions within the processing system 100.

Input device 106 receives input data 118 and may include, for example, a keyboard, a pointer device such as a pen-like device or a mouse, a tracker-ball, joystick or touch-screen, audio receiving device for voice controlled activation, such as a microphone, data receiver or antenna such as a modem or wireless data adaptor, data acquisition card, etc. Thus, an input device 108 may be operable by a user to enter input data 118, or it may receive data from another input data source. Thus, the input data 118 may be provided by different input devices 106. For example, in an embodiment the input data 18 may include keyboard or mouse instructions entered by a user, in conjunction with data received via a network. Preferably, the input device 108 includes a touch screen associated with an electronic reader.

Output device 108 produces or generates output data 120. In one embodiment, the output device 108 includes a display device (such as a computer graphics display) for providing output data 120 in a visual form.

In another embodiment, the output device 108 includes a display device or monitor together with a set of audio speakers in which case the output data 120 may be provided in an audio-visual form.

It will be appreciated that other types of output devices 108 may also be used, such as, a port (for example a USB port), a peripheral component adaptor, a data transmitter or antenna such as a modem or wireless network adaptor, etc.

It will also be appreciated that the output data 120 could be output from a variety of different output devices 108 such as, for example, a visual display on a monitor in conjunction with data transmitted to a network. In such an embodiment a user may view data output, or an interpretation of the data output, on, for example, a monitor or using a printer.

The storage device 114 can include any form of data or information storage means, for example, volatile or non-volatile memory, solid state storage devices, magnetic devices, etc.

The communications port 122 allows the processing system 100 to communicate with other devices via a hard wired or wireless network, such as network 80.

In use, the processing system 100 can be adapted to allow data or information to be stored in and/or retrieved from, via wired or wireless communication means, the at least one database 116. The interface 112 may allow wired and/or wireless communication between the processing unit 102 and peripheral components that may serve a specialized purpose. The processor 102 may receive instructions as input data 118 via input device 106 and can display processed results or other output to a user by utilising output device 108. Multiple input devices 106 and/or output devices 108 can be provided. In terms of the processing system 100, it should be appreciated that the processing system 100 may be any form of terminal, server processing system, specialised hardware, computer, computer system or computerised device, personal computer (PC), mobile or cellular telephone, mobile data terminal, portable computer, Personal Digital Assistant (PDA), pager or any other similar type of device.

### Embodiments of the Invention

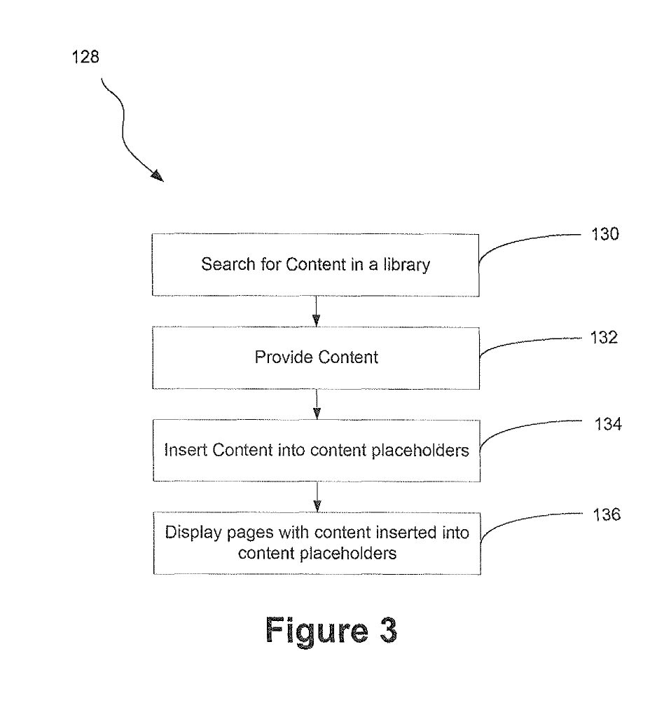

A method for providing an electronic document to a user will be described with reference to FIGS. 3-5. In this example, the electronic document is a Three Little Pigs story book having 21 pages, and multiple content placeholders associated with the pages. This example is given for illustrative purposes only, and the electronic document may be any story, stationery, presentation, storyboard, chain document whereby all contributors may make tagged contributions, scrapbook, movie etc. The electronic document may be downloaded by the user, for example to the electronic book reader 82, it may have been copied to the reader 82 from a computer readable medium, such as a DVD or USB device or it may be preinstalled on the reader 82 when purchased. The electronic document may thus be saved in memory 104 of the reader 82. In an alternative, the electronic document may be sent to a user via electronic mail. This is sometimes preferable when the electronic document is in the form of stationery—the stationery consisting of one or more pages with one or more content placeholders having pictures, audio and or video as backing for example and being forwarded to one or more users. In one form, stationery may consist of one or more pages and appear as an electronic business card having one or more images, backgrounds, animations, music, sounds, or photographs shown at different content placeholders in the stationery. The one or more images, backgrounds, animations, music, sounds, or photographs used may, for example, be related to the business and/or employee using the card. Advantageously, the card can be provided electronically to another person and through the use of content placeholders having video/audio etc, an enhanced business card is provided,

Also saved in memory 104 of the reader 82 is software for carrying out the method according to an embodiment of the present invention. The software may also be downloaded to the reader 82 via the internet 96 or installed from a computer readable medium. The software may be usable with multiple different electronic documents, for example documents created by different authors.

In another embodiment, the software may be saved in memory 104 of an external server, for example server 92 and accessed by the reader 82 over the internet 96, via its communication port 122.

The electronic document may contain text, it may contain a video/audio recording of the document being read, or it may contain a combination of both. Content such as images, backgrounds, smells, animations, music, sounds, games and photographs are shown at different content placeholders in the electronic document. Some content placeholders may contain no content.

The user, for example a child, may browse through the pages of the electronic document and read the story or listen to a recording of the story. The software causes the electronic document to be displayed on an output device 108, such as a display screen. The child may navigate through the document by using an input device 106, such as a touch screen on the reader 82 to turn the page, or the software may cause the next page to be displayed automatically once all the content on the previous page has been displayed. An indication to turn the page may be provided via an indicator component, such as an arrow prompt.

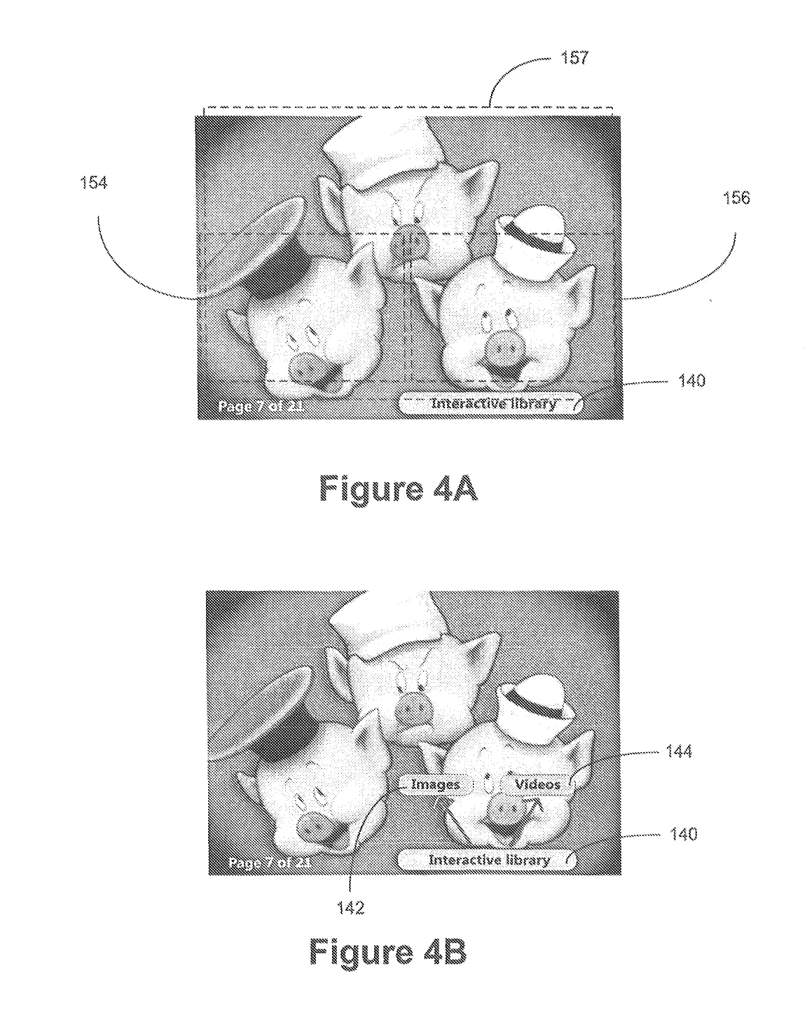

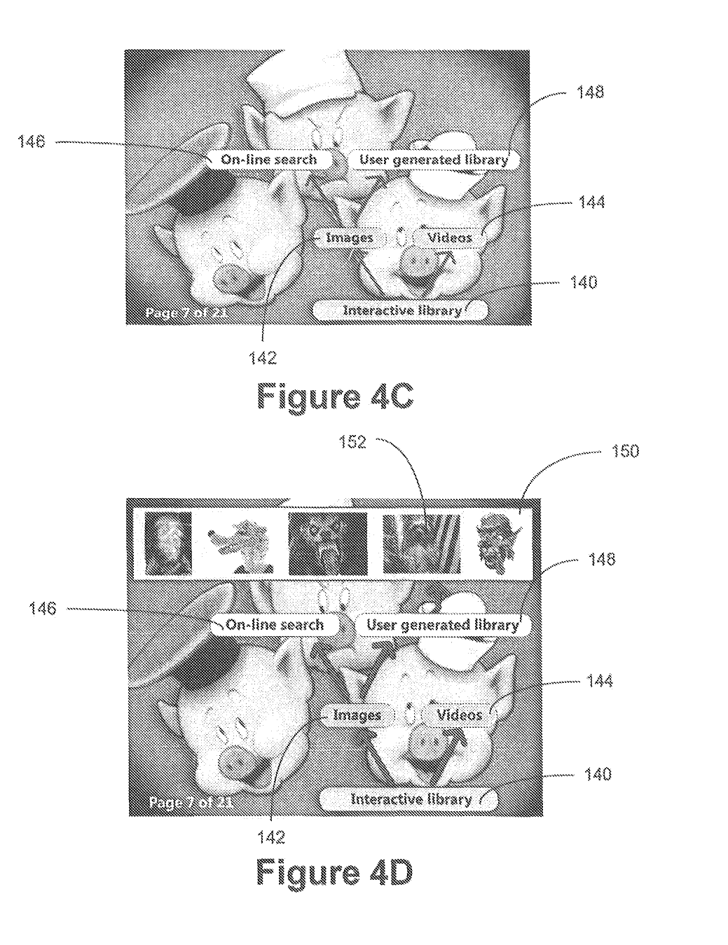

The child, or another user such as the child's parent, may then decide that they would like to change some of the content in the electronic document. For example, the user may grow tired of the content on a selected page, such as page 7 shown in FIG. 4A, and wish to update it. Page 7 has three content placeholders 154, 156 and 157, as shown in FIG. 4A. Content placeholder 154 defines a position in the bottom left of page 7 which may fade in soon after page 7 is displayed. Content placeholder 156 defines a position in the bottom right of page 7, which may fade in a short time after the content in content placeholder 154 appears. Content placeholder 157 defines an area covering most of the page, where a background may be inserted.

The content placeholders may be indicated to the user by a white outline or highlighting of the position of the content placeholder when the user selects an option for replacing content, for example by touching an “images” or “text” button.

FIG. 3 shows a method 128 for providing an electronic document to a user according to an embodiment of the invention. At step 130, the software enables the user to search for content in a library of content. This searching will be described in more detail below. The software then provides content for insertion into the electronic document at step 132, for example by downloading content and storing it in the memory 104 of the electronic reader 82. At step 134, the software inserts content into one or more content placeholders in response to a request by the user. For example, the user may use a touch screen (or other input device 108) to select content to be inserted. One or more pages of the electronic document are then displayed on the display screen of the reader at step 136 with the content inserted in the one or more content placeholders.

As described above, at step 130, the software enables the user to search for content in a library of content. The search may be initiated by touching the “Interactive Library” button 140 on page 7 of the document, shown in FIG. 4A. Touching this button on the touch screen causes a decision tree to be displayed. As shown in FIG. 4B, the user may choose between two different type of content by touching the “Images” button 142 or “Text” button 144. Other options may also be provided to the user, for different types of content such as video clips, sounds, music, games and photographs or combinations of these media. Touching a content button, such as the “Images” button 142, causes an “On-Line search” button 146 and “User generated library” button 148 to appear as shown in FIG. 4C. The “On-Line search” button 146 is linked to a function that enables the user to search for content on the internet 96, for example by searching content sharing websites such as YouTube™ or Flickr™, or by conducting internet searches using a search engine.

The “User generated library” button 148 is linked to a function that enables the user to search for content in a personal library of content. This library may contain content previously downloaded in an on-line search, content provided with the electronic book and content created by the user or the user's friends. The content may be created specifically for inclusion in the electronic document (for example a video of a person reading part of the document, made using a webcam or a sound effect recorded using a microphone), or it may be independent content. For example, the content may be obtained from social networking sites such as Facebook™.

Another embodiment may contain a separate button for accessing content in a “Public library”. The “Public library” may contain shared content created by other users of the electronic document. Selecting the “Public library” button will enable the user to search for content on a server, such as server 92, dedicated to providing a library of content for insertion into the electronic document.

A “webcam” button may also be included, for recording video clips using a webcam attached to the user's electronic reader 82 or computer 90.

As shown in FIG. 4D, clicking on the “User generated library” button 148 in the “Images” decision tree causes a series of images 150 from the user's personal library to be displayed at the top of the screen. The software thereby provides content for insertion into the electronic document, at step 132 of the method. In this example, the library is a library of images suitable for depicting the “big bad wolf”. The images 150 include a photo 152 of the user's dog. The user may choose to insert the photo 152 into a content placeholder 154 on page 7 and may request insertion of the photo 152 by touching it on the touch screen or dragging it into a content placeholder. At step 134, the software causes the photo to be inserted into the content placeholder 154 in the electronic document. Using a similar process, the user may also insert a video clip of a celebrity reading part of the Three Little Pigs story into the content placeholder 156. In the context of the Three Little Pigs story, the part may include, for example, a narration of the big bad wolf blowing down the house of sticks.

Preferably, the user can preview the page, and then make changes to content as desired until the page is finalised.

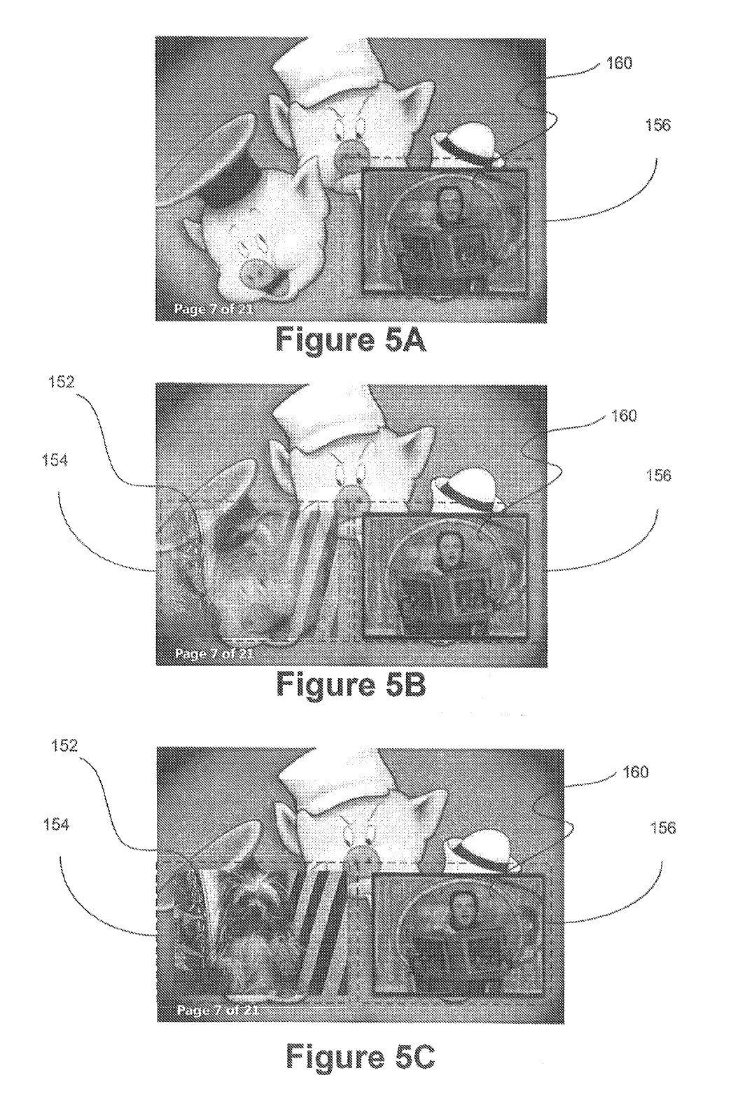

With reference again to FIG. 3, at step 136 the software causes the pages of the electronic document to be displayed with the content inserted in the content placeholder 154 and 156. Therefore, the next time the child interacts with the Three Little Pigs story book, page 7 will appear as shown in FIGS. 5A-5C.

As can be seen in FIG. 5A, when page 7 is displayed on the display screen 108, the video clip 160 of the celebrity is first shown at the bottom right of the screen. The photograph of the dog 152 is then faded in as seen in FIG. 5B and is displayed at the bottom left of the screen, alongside the video clip 160, as seen in FIG. 5C.

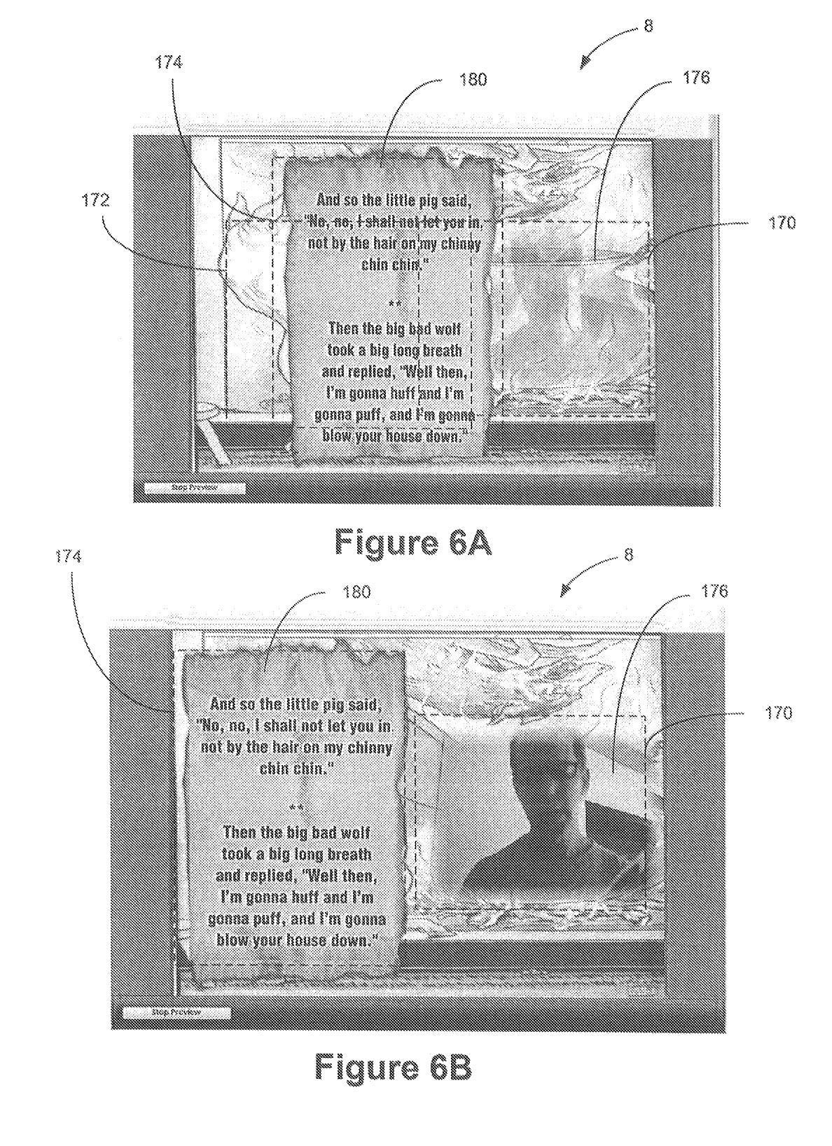

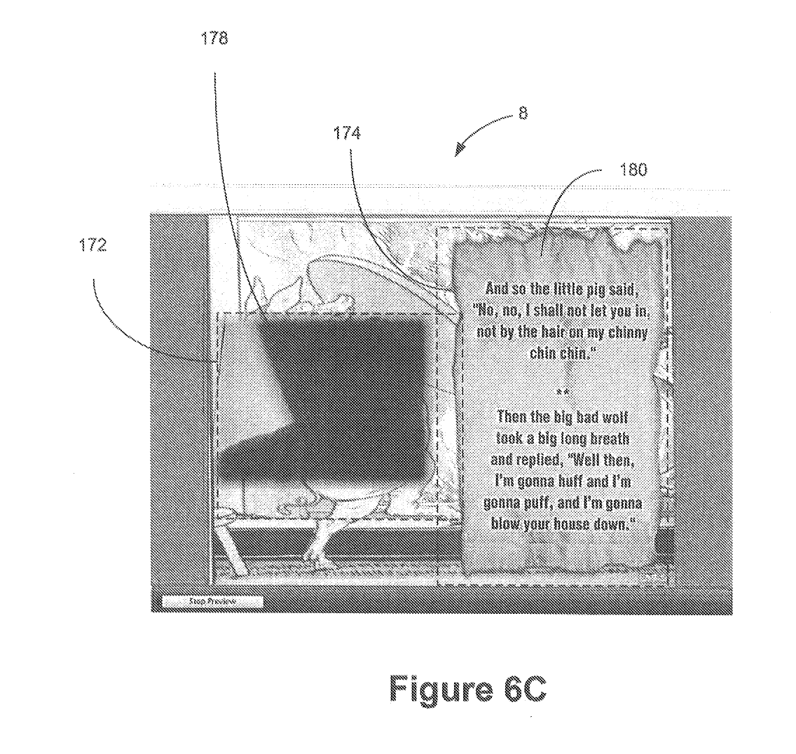

An example of another page 8 of the Three Little Pigs story is shown in FIGS. 6A-6C. In this page 8, a content placeholder 170 defines a position in the middle right hand side of the page 8 for content to fade in and then fade out. Content placeholder 172 defines a position in the middle left hand side of the page 8 for content to fade in and then fade out after content at content placeholder 170 has faded out. Further content placeholder 174 defines a position that moves from the middle left to the far left then to the right of the screen and is present throughout the display of the page 8.

In the example shown in FIGS. 6A-6C, the user has requested the software to insert a video clip 176 (e.g. of the child's father reading part of the story) into content placeholder 170. The user has also requested that another video clip 178 of Jack Nicholson reading the part of the wolf be inserted into content placeholder 172. The user has further entered some text 180 into the content placeholder 174.

When page 8 is displayed, the video clip 176 fades into the position defined by content placeholder 170 (FIG. 6A) with the text 180 moving left to make room for the clip 176 (FIG. 6B). After the video clip finishes, the text 174 moves to the right and the video clip 178 of Jack Nicholson appears on the left of the screen (FIG. 6C).

Pages or content created by the user need not be designed for existing electronic documents, but a user may instead create a new electronic document using the software. A user may also create a new page or multiple pages to be inserted between other pages in an existing electronic document. The new page/s may add new elements, characters and/or plots.

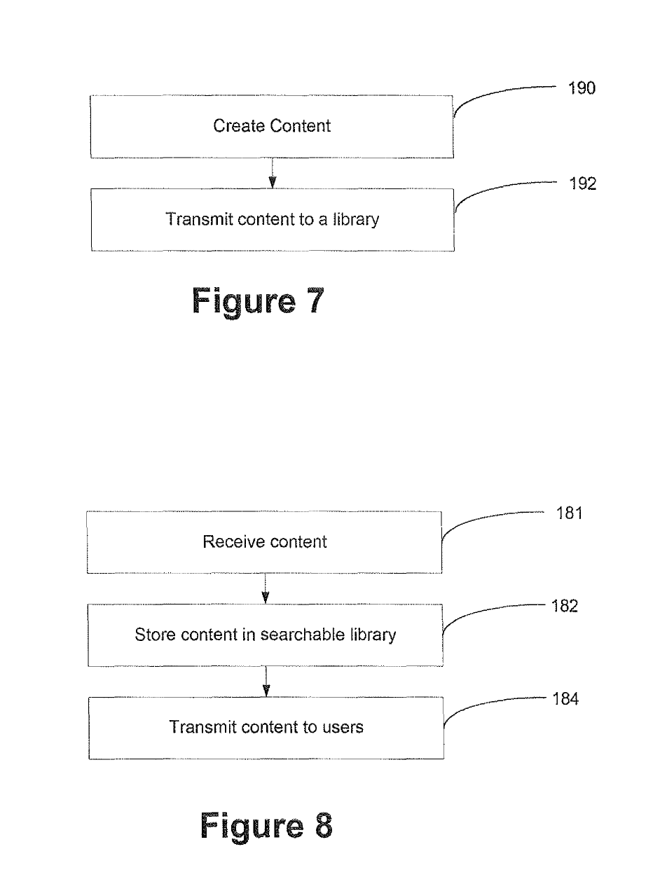

FIG. 7 shows a method for sharing content with one or more users. At step 190, the software enables content to be created for insertion into the electronic document, and at step 192 the software transmits the created content to a searchable library. The content may be a new page for inclusion in an electronic document.

The content may be designated as interactive content, which other users can save, alter, effect a chain, or any other hybridized interactive use desired.

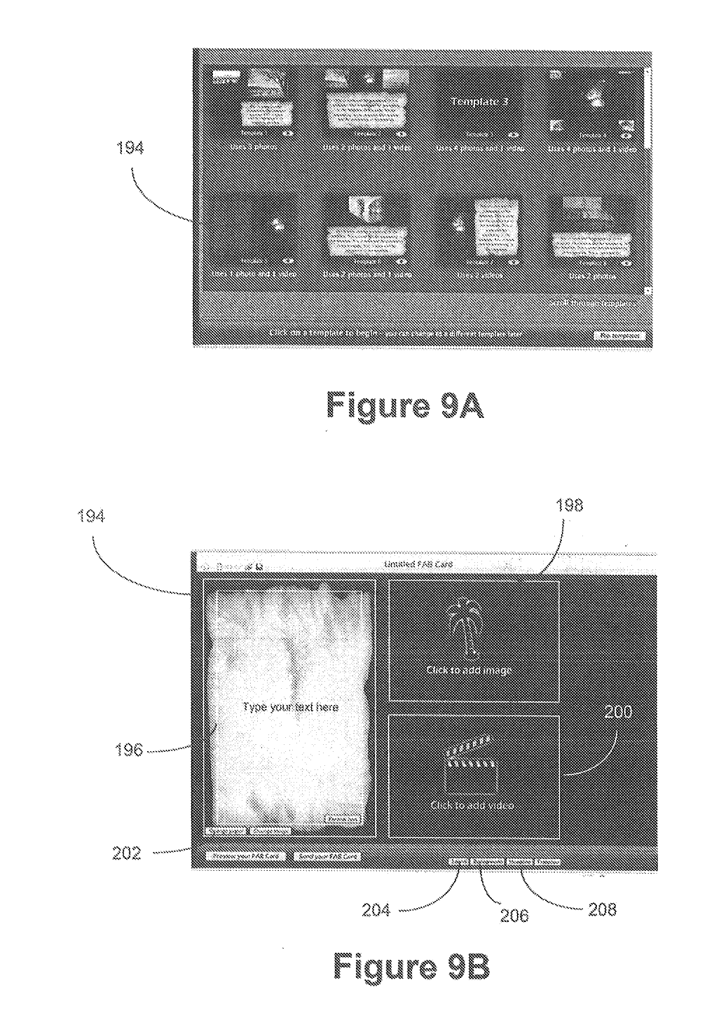

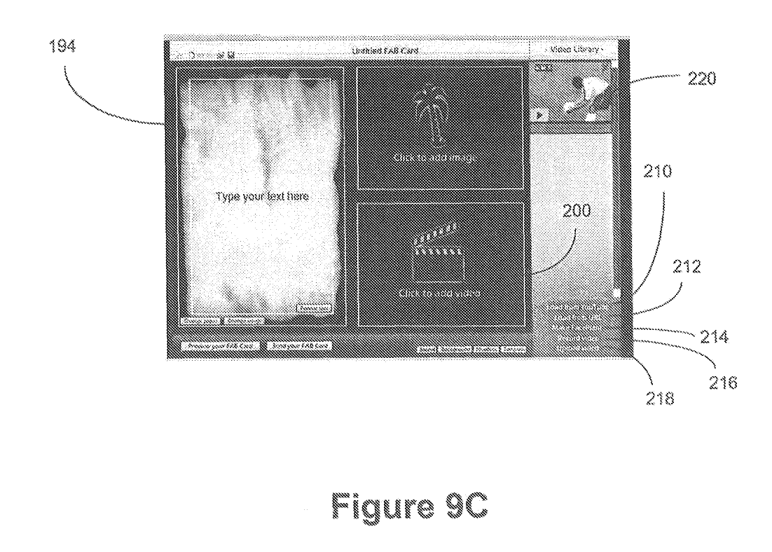

An example of creating a page will be described with reference to FIGS. 9A-9C. As shown in FIG. 9A, the software may provide the user with a selection of templates having different content placeholders such as for positioning 3 photos, 2 photos and 1 video, 4 photos and 1 video. The content placeholders may have different positions from template to template. The user may select one of the templates by clicking on it or touching it, using the input device 106.

Clicking on template 194 causes it to be displayed with content placeholders 196, 198 and 200 indicated by white boxes, as shown in FIG. 9B. Content placeholder 196 defines a position on the left side of the display screen where the user may enter text, content placeholder 198 defines a position on the top right of the display screen where the user may insert an image, and content placeholder 200 defines a position on the bottom right of the screen where the user may add a video. Alternatively, the content placeholder could contain a game, such as a flash game which may be related to a story or the subject matter of the electronic document being created. The game may be retrieved from a library of content may be made available via a server 92. In an embodiment, the game could be displayed and upon completion of the game, or upon a designated outcome, or in a ‘game over’ situation the rest of the content in the electronic document may play.

Other content placeholders are indicated by buttons on the display screen. The “Change paper” button 202 is associated with a content placeholder that positions an image of paper behind the text on the left side of the display screen. Clicking the “Change paper” button 202 allows a new image of paper to be inserted into the content placeholder. The “Sound” button 204 is associated with a content placeholder that defines when a sound file is to be played after the page is displayed. Clicking the “Sound” button 204 allows the user to select a sound file, for example looped background music, to insert into this content placeholder. The “Background” button 206 is associated with a content placeholder that defines an area covering most of the page and positioned behind other elements on the page, where a background may be inserted. The “Headline” button 208 defines a page that appears before the completed template 194 is displayed. Clicking on the “Headline” button 208 allows text to be inserted by the user.

FIG. 9C shows options for a user to search for or create a video for insertion in the content placeholder 200. The options are shown by buttons that the user may click on or touch on a touch screen. The buttons include a “Load from YouTube” button 210, to search YouTube for a video, a “Load from URL” button 212, to enter a URL of a video file, a “Make FacePlant” button 214, to put a picture, e.g. of the user's face, over the face of a person in a silly video, a “Record video” button 216 to record a video clip using a webcam and an “Upload video” button 218 to upload a video from the user's computer. Videos created by the user, such as video 220 are placed into their video library, and may be inserted into content placeholder 200.

The software may allow the user to create content by modifying other content, for example by changing the brightness, transparency, feathering the edges or other formatting features of images, or “face planting” into images or videos.

Once the user has finished adding content to the page, the user may request the software to transmit the page to a library of content. If the page is designed for insertion at a specific page of an existing electronic document, the software may nominate, for example page 3 of a unique document ID when transmitting it. Alternatively, the user may request the software to transmit specific content, for example video 220 to a library of content. In this case, the software may nominate, for example, page 3 associated with a unique document ID, content placeholder #3, when transmitting the video 220.

As described above, the library of content may be made available via a server 92. It may be stored on a database 93 connected to the server 92 or in memory 104 of the server 92. Of course, it will be appreciated that the library may be stored across multiple databases and servers. The library may include content for insertion at a selected page. For example, different users/celebrities/artists may create a page 7 of the Three Little Pigs book, and a user may select their favorite page 7 to insert into their book. The library may also include content for insertion at a selected content placeholder. For example, different people may record video clips of themselves reading page 7 of the story, to be inserted into content placeholder 156. In another example, different people may create artwork for the background of a particular page or any page of the electronic document.

With reference to FIG. 8, at step 181, content is received from different users on the communication port 122 of the server 92. Software stored in memory 104 on the server 92 stores the received content in the library at step 182. Users may then search the library, for example a user of computer 88 may conduct a search via a website served by server 92. The user may select content for inclusion in their electronic document. The software stored in memory 104 on the server 92 then causes the selected content to be transmitted to the computer 88 at step 184. The user can then insert the content into content placeholders in their electronic document, and view the document on the computer 88 or on the electronic book reader 86.

Over time through user submissions, electronic documents may evolve, for example, in other languages which would be beneficial for language learning and teaching.

Each electronic document may become its own franchise allowing a variety of evolvements and offspring stories. Enterprises such as businesses, research institutions or sporting teams could create electronic documents to recreate moments in history interactively or share ideas for the future interactively, or open source problem solving interactively under any set of defined frameworks. The present invention may empower and leverage a greater variety of creative pathways in document formation.

Some documents may have pages which include entire songs or whole feature length films as part of the content. For example, a 240 page document entitled The Frank Sinatra Story might have at the end of page 74, a two hour film called, The Manchurian Candidate, in which Sinatra starred or a document/story about war could have the entire movie ‘Patton’ on page 21 introduced by a textual passage by Hemmingway from his novel, ‘A Farewell To Arms’ with commentary in a ‘host box’ by grandpa who served on a battleship in World War II.

Another document might include amongst its pages a variety of full length films by a particular film director such as Martin Scorsese which reflect the creator's favorites or a variety of artists, directors, paintings, graphs etc. of varying timelines could inhabit the pages for any number of category, research, or plot driven narratives. Such a vast collection of media potentially encompassing each page may cater to and yield a wide variety of content absorption rates ranging from seconds to hours while still appealing to a broader audience.

In some cases the creator could make the determination when a flashing arrow prompt would notify the audience when the minimal amount of time has passed without missing vital information. In other cases, the page might turn automatically when all the content has finished displaying.

In addition, an interactive document could essentially chronicle one's life by the various progressive changes made to the same document over a period of years or more accurately measure psychological and developmental aspects.

Any document could at various stages be posted online as available to interact with in any of the aforementioned ways by any and all persons creating chains and or collaborations in virtually every creative, academic, or topical field of study or entertainment.

An electronic document in the form of a card may also be provided in which a content placeholder is provided for a background image which contains the head and shoulders of an athlete. A further content placeholder is arranged over the face of the athlete so that a fan of the athlete can superimpose an image of their face on the athlete. Such an electronic document might be called a ‘Faceball card’. Other content placeholders may be used to communicate the statistics of the athlete, their bio, pictures, video and sound combined into a profile.

Optional embodiments of the present invention may also be said to broadly consist in the paths, elements and features referred to or indicated herein, individually or collectively, in any or all combinations of two or more of the paths, elements or features and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

1. A method for providing an electronic document to a user, the electronic document having one or more pages and one or more content placeholders associated with the pages, the method including the steps of:
(a) providing content for insertion into the electronic document,
(b) inserting content into one or more content placeholders in response to a request by the user, and
(c) displaying the one or more pages of the electronic document with the content inserted in the one or more content placeholders.

2. The method of claim 1, wherein the one or more content placeholders defines one of a position on one or more pages of the electronic document, a time associated with one or more pages of the electronic document, or both a position on and time associated with one or more pages of the electronic document.

3. The method of claim 1, further including the step of
searching for content in a library of content for insertion into the electronic document.

4. The method of claim 1, further including the step of
searching for content in a library of content for insertion at a selected page of the electronic document.

5. The method of claim 1, further including the step of
searching for content in a library of content for insertion at a selected content placeholder in the electronic document.

6. The method of claim 1, wherein the content inserted at different content placeholders is selected from one or more different sources.

7. The method of claim 1, wherein the content includes one or more of: an image, a video clip, text, a sound, music, a game, a photograph, a smell, an animation

8. The method of claim 1, wherein the content includes a combination of two or more of: an image, a video clip, text, a sound, a game, music, a photograph, a smell, an animation

9. The method of claim 1, wherein the content includes a video clip of a person reading at least part of the electronic document.

10. The method of claim 1, further including the steps of
(a) providing one or more pages for insertion into the electronic document, and
(b) inserting a page into the electronic document in response to a request by the user.

11. Software for use with a computer including a processor and associated memory device for storing the software, the software for providing an electronic document to a user, the electronic document having one or more pages and one or more content placeholders associated with the pages, the software including a series of instructions to cause the processor to carry out the steps of:
(a) providing content for insertion into the electronic document,
(b) inserting content into one or more content placeholders in response to a request by the user, and
(c) displaying the one or more pages of the electronic document with the content inserted in the one or more content placeholders.

12. A computer readable media containing software for use with a computer including a processor and associated memory device for storing the software, the software for providing an electronic document to a user, the electronic document having one or more pages and one or more content placeholders associated with the pages, the software including a series of instructions to cause the processor to carry out the steps of:
(a) providing content for insertion into the electronic document,
(b) inserting content into one or more content placeholders in response to a request by the user, and
(c) displaying the one or more pages of the electronic document with the content inserted in the one or more content placeholders.

13. An apparatus for providing an electronic document to a user, the electronic document having one or more pages and one or more content placeholders associated with the pages, the apparatus including:
(i) a processor,
(ii) a memory,
(iii) a user interface including an input device and an output device, and
(iv) a software program resident in memory accessible to the processor, the program executable by the processor to carry out the steps of:
(a) providing content for insertion into the electronic document,
(b) inserting content into one or more content placeholders in response to a request by the user, and
(c) displaying the one or more pages of the electronic document with the content inserted in the one or more content placeholders.

14. A method for sharing content with one or more users for insertion in an electronic document having one or more pages and one or more content placeholders associated with the pages, the method including the steps of:
(a) creating content for insertion into the electronic document, and
(b) transmitting the created content to a library that is searchable by the one or more users for insertion of the content into one or more content placeholders associated with one or more pages of an electronic document.

15. The method of claim 14, further including the step of:
nominating a page of the electronic document that the content is designed to be inserted into.

16. The method of claim 14, further including the step of:
nominating a content placeholder in the electronic document that the content is designed to be inserted into.

17. A method for providing content to one or more users for insertion in an electronic document having one or more pages and one or more content placeholders associated with the pages, the method including the steps of:
(a) receiving content for inclusion in the electronic document,
(b) storing the received content in a library that is searchable by the one or more users, and
(c) transmitting content to a user on selection by the user, for insertion at one or more content placeholders in the user's electronic document.

18. The method of claim 17, wherein the received content is for insertion at a nominated page of the electronic document, and is stored in a library of content for insertion at that page.

19. The method of claim 17, wherein the received content is for insertion at a nominated content placeholder in the electronic document, and is stored in a library of content for insertion at that content placeholder.

20. The method of claim 17, wherein the content is a video clip of a person reading at least part of the electronic document.

21. A server for providing content to one or more users for insertion in an electronic document having one or more pages and one or more content placeholders associated with the pages, the server including:
(a) a processor,
(b) a memory storing a library of content for insertion into the electronic document,
(c) a user interface including an input device and an output device, and
(d) a software program resident in memory accessible to the processor, the program executable by the processor to:
(a) receive content for inclusion in the electronic document,
(b) store the received content in a library that is searchable by the one or more users, and
(c) transmit content to a user on selection by the user, for insertion at one or more content placeholders in the user's electronic document.
